(19) United States
(12) Patent Application Publication
(10) Pub. No.: US 2006/0233283 A1
(43) Pub. Date: Oct. 19, 2006

(54) Demodulator with individual bit-weighting algorithm

(75) Inventors: Insung Kang, San Diego, CA (US); Qiang Shen, San Diego, CA (US); Tarun K. Tandon, San Diego, CA (US)

Correspondence Address: Howard Chen, Preston Gates & Ellis LLP;Suite 1700, 55 Second Street, San Francisco, CA, 94105, US

(73) Assignee: VIA Telecom Co., Ltd.

(21) Appl. No.: 11/107,185

(22) Filed: Apr. 15, 2005

(51) Int. Cl. H04L 27/00; H04L 27/22

(52) U.S. Cl. 375/324; 375/332

(57) ABSTRACT

A method and system is disclosed for weighting soft values of a demodulated symbol. An incoming symbol is demodulated for obtaining a plurality of soft values associated with the incoming symbol based on a modulation constellation. An effective signal-to-noise ratio (SNR) of at least one soft value, which is to be a reference for decoding, is obtained, as well as effective SNRs of all other soft values. A set of weights are then calculated for the soft values based on a ratio between each SNR and the reference, wherein the weights are applied to the soft values based on the ratios for further decoding thereof.

### BACKGROUND

The present invention relates generally to digital communication systems and more particularly to digital communication systems employing M-phase shift keying (M-PSK) or M-quadrature amplitude modulation (M-QAM) modulation.

A digital communication system carries a stream of binary information, and the quality thereof is constantly changing due to changes in the communications channel medium, traffic profile changes, etc. As is known by those skilled in the art, this said binary information can be divided into manageable segments, known as packets, to facilitate error detection and to retransmit certain portions of the data stream. Packets can also be further subdivided into clusters of significant bits known as symbols. For example, a symbol used for the transmission of videoconferencing data might contain one bit designated as voice and three bits representing the video image. The relationship of bits m in a symbol and the number of 1 positions M in a signal constellation is M=2^{m}.

One measure of a communication system's performance is its bit error rate (BER). The BER is the number of bit errors that have occurred during the transmission and is measured as the number of bit errors in a quantity of bits (such as 1 error in 1000 bits). The BER is inversely proportional to the system signal-to-noise ratio (SNR). As the SNR is increased, the BER decreases.

M-PSK and M-QAM modulation are modulation techniques commonly used in communication systems. In M-PSK modulation, the carrier changes between different phases as determined by the logic states of the input data bit stream. The M-QAM modulation is a composite modulator consisting of amplitude and phase modulation. The M in M-PSK signifies the number of phase positions that have been modulated. In a 4-PSK system, 4 phases are modulated, and in a 16-PSK system, 4 phases are modulated. Further as an example, in an 8-PSK modulator, 3 bits are processed to produce a single phase change. This means that each symbol in an 8-PSK system contains 3 bits.

In a typical 8-PSK communication system, the binary data digits are encoded, interleaved, and phase modulated onto a carrier signal. The carrier signal is then transmitted via various types of communications channels such as air, coaxial cable, fiber optic lines, etc. At the receiver, the carrier is demodulated, de-interleaved, and decoded to generate an estimate of the original binary data bits. These estimates are called “soft values”.

A signal constellation diagram is used to represent the different combinations of bits in a symbol (an 8-PSK system contains 3 bits). Each combination of bits map to a unique phase angle on the constellation. In an 8-PSK system with 8 phases, each of the 8 phases represents 45 degrees in the constellation (as shown in FIG. 3). In a conventional demodulator for an 8-PSK constellation, the demodulator weights each bit equally in terms of SNR because the constellation is symmetrical. However, as a result of the same weighting factor for each bit about the constellation, the decoder SNR is limited, thereby resulting in a higher BER, which limits the decoder performance.

Therefore, desirable in the art of M-PSK and M-QAM demodulators are improved demodulator designs that increase the demodulator SNR, and thereby lowering the demodulator BER and increasing decoder performance.

### SUMMARY

In view of the foregoing, this invention provides circuits and methods to improve demodulator/decoder performance and its bit error rate through the incorporation of an individual bit-weighting algorithm, and thereby increase the demodulator's signal-to-noise ratio (SNR). A method and system is disclosed for weighting soft values of a demodulated symbol. An incoming symbol is demodulated for obtaining a plurality of soft values associated with the incoming symbol based on a modulation constellation. An effective signal-to-noise ratio (SNR) of at least one soft value, which is to be a reference for decoding, is obtained, as well as effective SNRs of all other soft values. A set of weights are then calculated for the soft values based on a ratio between each SNR and the reference, wherein the weights are applied to the soft values based on the ratios for further decoding thereof.

In one embodiment, a fixed-point M-PSK demodulator incorporating an individual bit-weighting algorithm is implemented after or before a quantizer. The incorporation of the bit-weighting algorithm increases the demodulator SNR, which in turn decreases the demodulator BER, thus improving the demodulator decoder performance.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 presents a typical communication system.

FIG. 2 presents a typical demodulator module design.

FIG. 3 presents a typical 8-signal PSK constellation diagram.

FIG. 4 presents a fixed-point demodulator with individual bit weighting before a quantizer in accordance with a first embodiment of the present invention.

FIG. 5 presents a fixed-point demodulator with individual bit weighting after a quantizer in accordance with a second embodiment of the present invention.

### DESCRIPTION

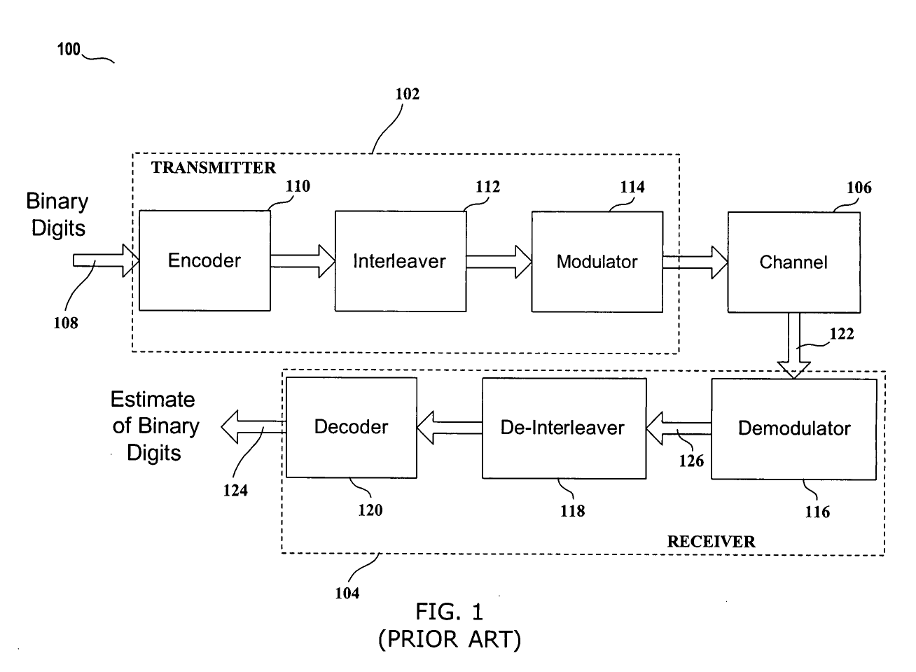

FIG. 1 presents a typical digital communication system 100 comprising a transmitter 102 coupled to a receiver 104 via a communications channel 106. The input signal of binary digits 108 can represent digitized voice, digitized video signal, or digital signals from a PC or computer system. The output of the receiver 104 is an estimate 124 of the input signal of binary digits 108.

The transmitter 102 comprises an encoder module 110 to be coupled to an interleaver module 112, which is further coupled to, and provides data inputs to a modulator module 114. The input signal of binary digits 108 to the encoder module 110 is a string of data bits arranged in any well-known format. Although the encoder module 110, the interleaver module 112, and the modulator module 114 are shown in FIG. 1 as separate devices, it is understood by those skilled in the art that they can be integrated together as one or more parts of a signal processing system.

The encoder module 110 can be a bit processing device that adds bits to the incoming data stream of binary digits 108 to allow for error correction at the receiver. The interleaver module 112 is also a bit processing device that alters the time order of the bits from the encoder module 110 to produce a modified output stream. The interleaver module 112 introduces time diversity in the bit stream without adding additional bits in the data stream. Interleaving is used to distribute burst errors over many channel blocks, so that the number of errors in each block is limited.

The modulator module 114 is designed to digitally modulate signals with a well-known spectrally efficient modulation technique such as PSK or QAM. In this disclosure, the modulator module 114 is an M-PSK modulator, where M represents the total number of different groupings of bits that can be transmitted by the modulator. As an example, if M equals 8, there will be 8 phase signals. Each grouping of bits (symbol) contains 3 bits (N=log₂ M). Where, each bit can carry a different bit energy level.

The modulation process maps the incoming bits into symbols. One well known mapping technique is called “gray mapping”. The symbols are simply digital signals modulated in conformance with a particular modulation scheme such as PSK and QAM. To further illustrate, if 3 bits are transmitted at a 10 Khz rate, the bit rate is then 30 Khz. The symbol rate, which is also known as the baud rate, will be calculated by the bit rate divided by the number of bits in a symbol. If there is 1 bit per symbol, the symbol rate is then 30 Khz. If there are 2 bits per symbol, the symbol rate is 15 Khz.

There are various types of communications channels 106, such as air, coaxial cable, fiber optic lines, etc that may be utilized. Each of these communication channel media has adverse effects that alter the characteristics of the original transmitted signal. As is well known in communication theory, data transmitted through the communication channel 106 are subject to multiplicative distortions such as phase jitter, amplitude degradation and frequency translation that directly affect the transmitted signals.

The receiver module 104 is comprised of a demodulator module 116, a de-interleaver module 118, and a decoder module 120. The receiver module 104 receives the transmitted signal 122 via the communications channel 106 and generates an output signal containing the estimate 124, which is error-corrected.

Although the demodulator module 116, the de-interleaver module 118, and the decoder module 120 are shown in FIG. 1 as separate devices, they can be integrated together as parts of a signal processing based system.

The demodulator module 116 receives the transmitted symbols 122 and calculates soft values corresponding to the bits of the symbols. In essence, the demodulator module 116 is the one to convert symbols to bits, or in other words, it inverts the bit-to-symbol mapping. The de-interleaver module 118 resets the demodulator data bit stream to the same data stream that was output from the encoder module 110. The output of the de-interleaver module 118 is fed to the decoder module 120. The decoder module 120 calculates a set of distance metrics for each bit. The decoder module 120 finally generates the bit decision 124.

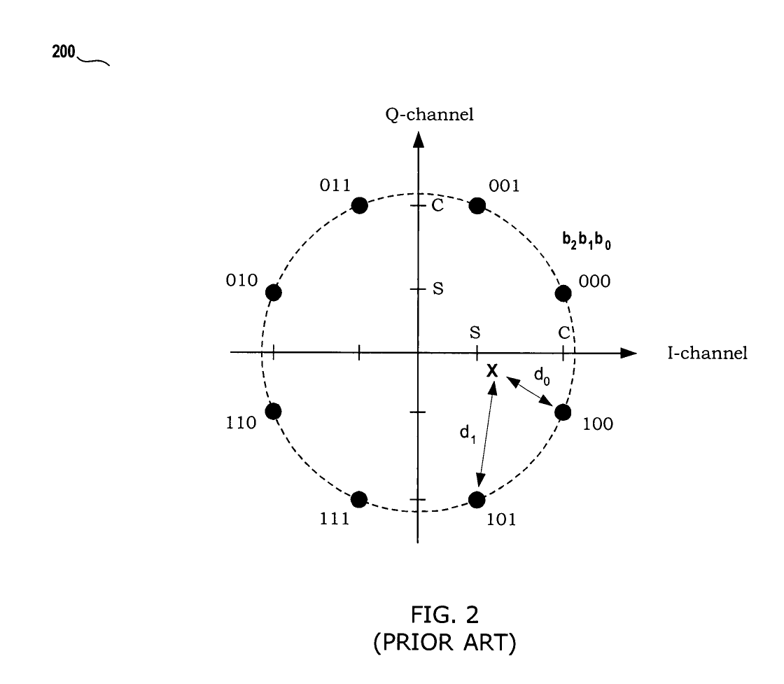

FIG. 2 presents a typical 8-signal PSK constellation diagram 200. Each of the eight points (dots) on the constellation diagram 200 represents one encoded data symbol. The phase angle of the constellation points is measured in degrees from the I-channel axis. This constellation diagram 200 provides 8 phases for conveying data symbols from the transmitter to the receiver. Each of the 8 constellation points in the constellation diagram 200 is defined by 3 bits (b2, b1, b0). For example, the constellation point 000 has a phase angle of 22.5 degrees as measured from the I-channel axis, while each successive point is an additional 45 degrees from the previous constellation point (e.g. 001 at 67.5 degrees, 011 at 112.5 degrees, etc.). It is further understood that in the present disclosure, the modulation constellation can be a symmetrical one as well as an asymmetrical one although the one shown in FIG. 2 is symmetrical.

One method of calculating the bit estimates (or soft values) in a typical digital communication system as shown in FIG. 1 is the log likelihood ratio (LLR) per bit. However, the full LLR method is complex and is typically replaced with a simplified form. In this example, the LLR is approximated by the ratio of the Euclidean distance d₀ and the Euclidean distance d₁. The Euclidean distance is the straight-line distance between two points. Where X is the received signal, d₀ is the distance from X to the closest constellation point belonging to a bit value of 0, and d₁ is the distance from X to the closest constellation point belonging to a bit value of 1.

In this example, an ad-hoc method is used to partition the signal space using the signal constellation symmetry:
(abs(I)−abs(Q))/√2
can be a bit 0 estimate for the 8-PSK signal constellation, where I is the in-phase component of the received signal X. The in-phase component I alone can be a bit 1 estimate. Q is the quadrature component of the received signal X. The quadrature component Q alone can be a bit 2 estimate.

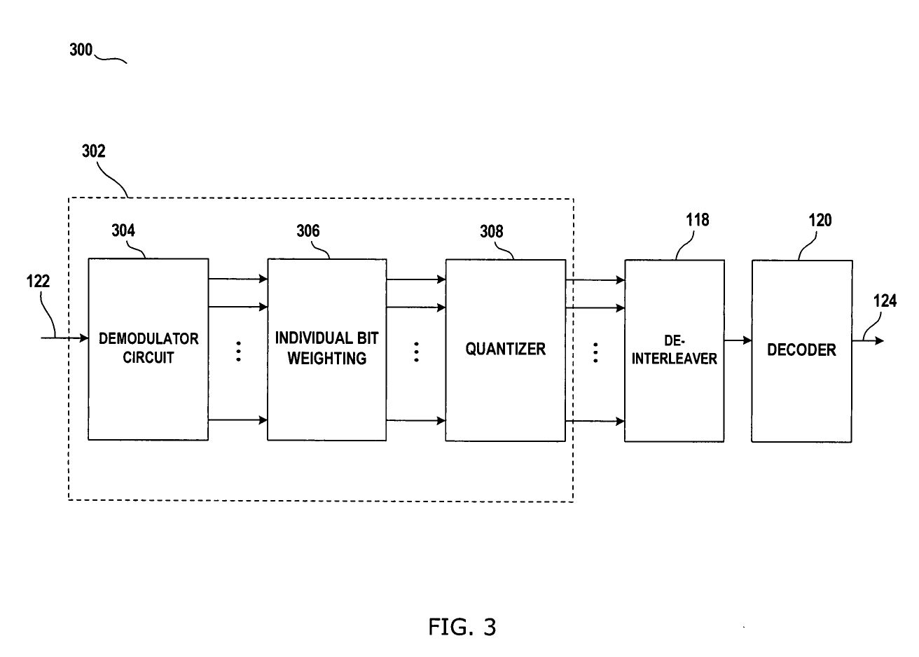

FIG. 3 presents an improved digital communication receiver 300 using a demodulator 302 (e.g., a fixed-point demodulator) with individual bit weighting before the quantizer in accordance with the first embodiment of this invention. The demodulator 302 is comprised of a demodulator circuit 304 to be coupled to an individual bit weighting module 306, which is to be further coupled to a quantizer 308. The demodulator 302 is used to process the transmitted signal 122. This processing involves algorithm used in the individual bit weighting module 306 to compute the energy for each bit estimate (soft value) and generates a set of weights that are applied to the soft values prior to decoding. The output of the demodulator 302 is sent to a typical de-interleaver, such as the de-interleaver module 118, and subsequently to a typical decoder, such as the decoder module 120 for further signal processing to produce the estimate 124. Since this new individual bit weighting method is used in lieu of the conventional method of equal bit weighting that limits the SNR, the decoder performance may be improved.

The 8-PSK demodulation scheme generates a plurality of soft values associated with the incoming symbol based on the signal modulation constellation. The individual bit-weighting algorithm computes a set of weights for the soft values based on a ratio between each soft value's SNR and a reference SNR. The calculated weight is then applied to the soft values for further decoding.

This individual bit weighting method first calculates an effective SNR on one soft value, which will be used as a reference for decoding. Then, the effective SNR for all other soft values will be calculated. Next a set of weights for the soft values will be calculated based on a ratio between each soft value SNR and the reference SNR. Finally, the calculated weight set will be applied to the soft values based upon the ratios for further decoding. This individual bit weighting algorithm will increase the demodulator SNR, which in turn will decrease its BER, thus improving the decoder performance.

In this example, consider the same ad-hoc demodulation scheme that was used in FIG. 2 for the 8-PSK signal constellation:
(abs(I)−abs(Q))/√2
where I, the in-phase component, and Q, the quadrature component, are used for the bit 0, bit 1, and bit 2 estimates.

Then, the effective SNR for bit 0 is:
SNR_{bit0}=(c−s)²*a²/2=0.44Es/N₀/2
where c=a cos(π/8), s=a sin(π/8), Es is the bit energy level of the signal and N₀ is the energy level of the noise involved, a=√6 Es/N₀.

Therefore, the effective SNR for bit 0 is:
SNR_{bit0}=0.88 at Es/N₀=0 dB

It is understood that Es is the bit energy before bit-to-symbol mapping, and after mapping (e.g., the modulation in this disclosure), the SNR changes between bits. The effective SNR is the SNR after mapping.

The effective SNRs for bits 1 and 2 are:
SNR_{bit1}=SNR_{bit2}=(c+s)²a²/4(1+a²/2−(c+s)²a²/4)=0.89Es/N₀/2

Therefore,
SNR_{bit1}=1.78 at Es/N₀=0 dB; and
SNR_{bit2}=1.78 at Es/N₀=0 dB.

The effective SNR of one soft value will be used as a reference for decoding all other soft values. In this example, bit 1 will be used as the reference for the bit weighting algorithm. Therefore:
Bit 0 weighting=√SNR_{bit0}/SNR_{bit1}=√0.88/1.78=0.7;
Bit 1 weighting=√SNR_{bit1}/SNR_{bit1}=√1.78/1.78=1; and
Bit 2 weighting=√SNR_{bit2}/SNR_{bit1}=√1.78/1.78=1.

As illustrated in FIG. 3, the demodulator module 304 provides various soft values corresponding to the bits of the symbols. When individual weights are produced in the bit weighting module 306, the weights are applied to the received soft values from the demodulator module 304. The individually weighted soft values are then optionally quantized for further de-interleaving and/or decoding purposes. As each soft value is appropriately adjusted with different weights, the soft values are processed differently through the decoding process and the decoding results are improved.

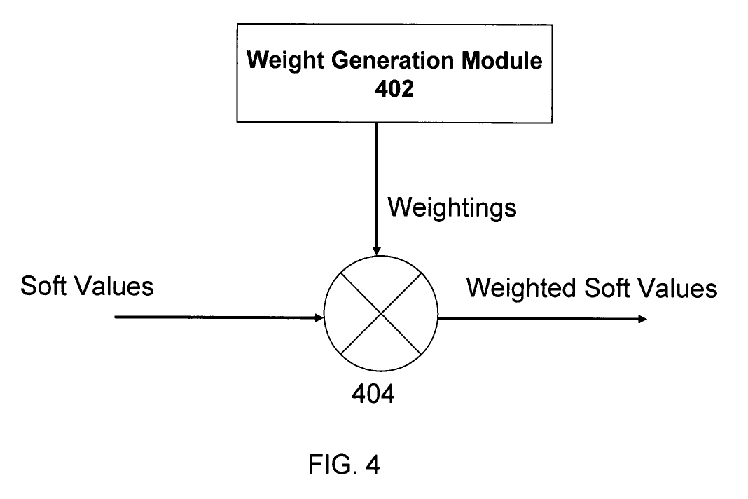

FIG. 4 illustrates a sample detailed view of the bit weighting module 306 of FIG. 3. A weight generation module 402 calculates the individual weightings as described above with regard to FIG. 3. The weight generation module 402 can be a separate processing module, but can also be integrated with the processor of the receiver to share the processing powers to generate the weightings. The weightings are then applied to a mixer 404. As the soft values are coming in, the weightings are applied. For example, the different weightings in the above example are 0.7, 1, and 1. Suppose the demodulator generates soft values sequentially, i.e. bit 0, bit 1, and bit 2 per received symbol. A multiplier changes the coefficient or the weightings by rotating among 0.7, 1, and 1 when the soft values are coming to the multiplier sequentially.

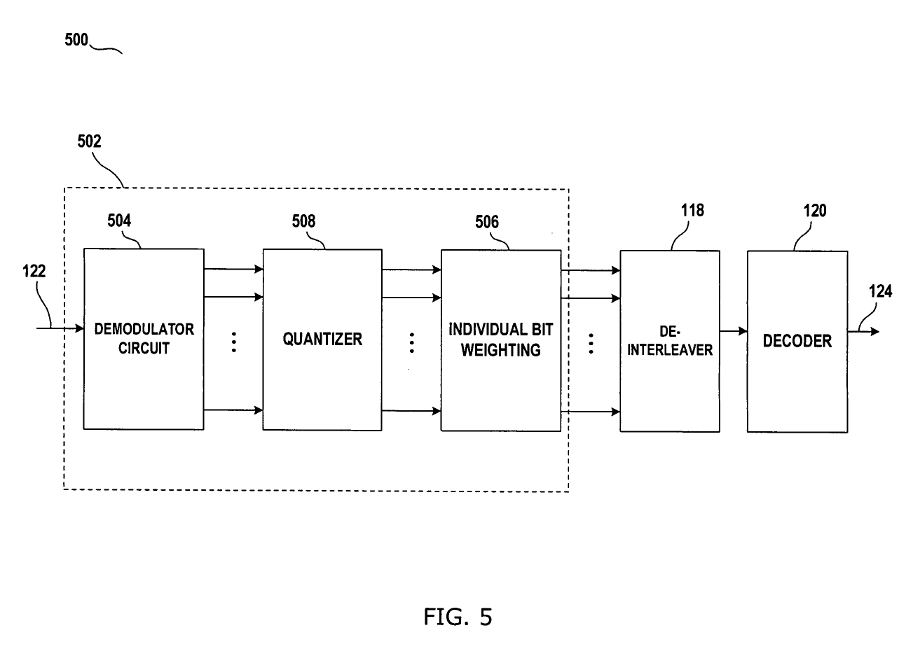

FIG. 5 presents a digital communication receiver 500 using a fixed-point demodulator 502 with individual bit weighting after the quantizer in accordance with the second embodiment of this disclosure. The demodulator 502 is comprised of a demodulator circuit 504 to be coupled to a quantizer 508, which is to be further coupled to an individual bit weighting module 506. The algorithm used in the individual bit weighting module 506 is the same as that used in the individual bit weighting module 406 wherein the energy is computed for each bit estimate and a set of weights is generated and to be applied to the soft values prior to decoding. The output of the demodulator 502 is sent to a conventional de-interleaver such as the de-interleaver module 118 and a conventional decoder such as the decoder module 120 for further signal processing. The modified configuration in the receiver 500 has similar decoder performance parameters as those of the receiver 400.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for weighting soft values of a demodulated symbol, the method comprising:
demodulating an incoming symbol for obtaining a plurality of soft values associated with the incoming symbol based on a predetermined modulation constellation;
calculating an effective signal-to-noise ratio (SNR) of each soft value;
identifying a reference SNR among the calculated SNRs;
calculating a set of weights for the soft values based on ratios between each SNR and the reference SNR,
wherein the weights are applied to the soft values based on the calculated ratios for further decoding thereof.

2. The method of claim 1 wherein the modulation constellation is symmetrical.

3. The method of claim 1 wherein the modulation constellation is asymmetrical.

4. The method of claim 1 further comprising quantizing the demodulated incoming signal prior to calculating the effective SNRs.

5. The method of claim 1 further comprising quantizing the demodulated weighted soft values.

6. The method of claim 1 wherein the demodulating uses an 8-PSK demodulation scheme.

7. A demodulation system comprising:
a demodulator circuit for demodulating an incoming symbol for obtaining a plurality of soft values associated with the incoming symbol based on a predetermined modulation constellation; and
individual bit weighting module for calculating an effective signal-to-noise ratio (SNR) of each soft value, identifying a reference SNR among the calculated SNRs, and calculating a set of weights for the soft values based on ratios between each SNR and the reference SNR,
wherein the weights are applied to the soft values based on the calculated ratios for further decoding thereof.

8. The system of claim 7 wherein the modulation constellation is symmetrical.

9. The system of claim 7 wherein the modulation constellation is asymmetrical.

10. The system of claim 7 further comprising a quantizer for quantizing the demodulated incoming signal prior to calculating the effective SNRs.

11. The method of claim 7 further comprising a quantizer for quantizing the weighted soft values.

12. The method of claim 1 wherein the demodulating uses an 8-PSK demodulation scheme.

13. A demodulation system comprising:
means for demodulating an incoming symbol for obtaining a plurality of soft values associated with the incoming symbol based on a predetermined modulation constellation;
means for calculating an effective signal-to-noise ratio (SNR) of each soft value, identifying a reference SNR among the calculated SNRs, and calculating a set of weights for the soft values based on ratios between each SNR and the reference SNR; and
means for quantizing the demodulated incoming signal,
wherein the weights are applied to the soft values based on the calculated ratios for further decoding thereof.

14. The system of claim 13 wherein the modulation constellation is symmetrical.

15. The system of claim 13 wherein the modulation constellation is asymmetrical.

16. The system of claim 13 wherein the quantizing the demodulated incoming signal is arranged prior to calculating the effective SNRs.

17. The system of claim 13 wherein the quantizing the weighted soft values.

18. The system of claim 13 wherein the demodulating uses an 8-PSK demodulation scheme.
